(19) United States
(12) Patent Application Publication
(10) Pub. No.: US 2014/0018006 A1
(43) Pub. Date: Jan. 16, 2014

(54) BROADCAST CONTENT FOR VEHICLE AUDIO SYSTEMS

(71) Applicants: David R. Petrucci, Warren, MI (US); Charles A. Massoll, Milford, MI (US); Thiep T. Nguyen, Macomb, MI (US); Mark A. Wisnewski, Stockbridge, MI (US)

(72) Inventors: David R. Petrucci, Warren, MI (US); Charles A. Massoll, Milford, MI (US); Thiep T. Nguyen, Macomb, MI (US); Mark A. Wisnewski, Stockbridge, MI (US)

(73) Assignee: GM GLOBAL TECHNOLOGY OPERATIONS LLC, Detroit, MI (US)

(21) Appl. No.: 13/547,586

(22) Filed: Jul. 12, 2012

(51) Int. Cl. H04W 4/00; H04W 4/04; H04B 1/40

(52) U.S. Cl. 455/66.1; 455/74

(57) ABSTRACT

Providing content services for a vehicle include receiving a signal quality indicator value indicative of a signal quality of a radio station that is transmitting radio frequency-based content over-the-air. The content services also include searching, via a wireless interface, a network for an identifier of the radio station. Upon determining the signal quality indicator value has fallen below a threshold, and responsive to finding the identifier of the radio station from the searching, the content services include transitioning from transmission of the content broadcast via radio frequency-based signals, through a radio of the vehicle, to transmission of content associated with the network.

### FIELD OF THE INVENTION

The subject invention relates to vehicle audio systems and, more particularly, to providing seamless transitioning between radio frequency-based broadcast signals and Internet-based digital streaming signals through a vehicle audio system based on signal quality.

### BACKGROUND

Vehicle audio systems provide a range of locally available over-the-air radio broadcast content, which is picked up by the vehicle's receiver in analog form and presented to the vehicle occupant through the audio system's speakers. As a vehicle operator travels or roams away from a locally broadcast source of radio frequency-based content, the quality of the radio broadcast signal is typically diminished. Absent any alternative communication transmission capabilities, such as, for example, satellite radio equipment and corresponding service arrangement, the operator is left with the choice of selecting another radio station whose radio signal broadcast range is within the area in which the operator is travelling.

Accordingly, it is desirable to provide a way to maximize the quality of content for a vehicle in transit.

### SUMMARY OF THE INVENTION

In one exemplary embodiment of the invention a system for implementing content services for a vehicle is provided. The system includes a wireless interface, a computer processing device communicatively coupled to the wireless interface, and logic configured to execute by the computer processing device. The logic implements a method. The method includes receiving a signal quality indicator value indicative of a signal quality of a radio station that is transmitting radio frequency-based content over-the-air. The method also includes searching, via the wireless interface, a network for an identifier of the radio station. Upon determining the signal quality indicator value has fallen below a threshold, and responsive to finding the identifier of the radio station from the searching, the method includes transitioning from transmission of the content broadcast via radio frequency-based signals, through a radio of the vehicle, to transmission of content associated with the network.

In another exemplary embodiment of the invention a method for implementing content services for a vehicle is provided. The method includes receiving a signal quality indicator value indicative of a signal quality of a radio station that is transmitting radio frequency-based content over-the-air. The method also includes searching, via the wireless interface, a network for an identifier of the radio station. Upon determining the signal quality indicator value has fallen below a threshold, and responsive to finding the identifier of the radio station from the searching, the method includes transitioning from transmission of the content broadcast via radio frequency-based signals, through a radio of the vehicle, to transmission of content associated with the network.

In yet another exemplary embodiment of the invention a computer program product for implementing content services for a vehicle is provided. The computer program product includes a computer storage medium having program instructions embodied thereon, which when executed by a computer processor cause the computer processor to implement a method. The method includes receiving a signal quality indicator value indicative of a signal quality of a radio station that is transmitting radio frequency-based content over-the-air. The method also includes searching, via the wireless interface, a network for an identifier of the radio station. Upon determining the signal quality indicator value has fallen below a threshold, and responsive to finding the identifier of the radio station from the searching, the method includes transitioning from transmission of the content broadcast via radio frequency-based signals, through a radio of the vehicle, to transmission of content associated with the network.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a diagram of a system upon which content services may be implemented in an exemplary embodiment; and

FIG. 2 is a flow diagram of a process for implementing content services in an exemplary embodiment.

### DESCRIPTION OF THE EMBODIMENTS

The following description is merely exemplary in nature and is not intended to limit the present disclosure, its application or uses.

In accordance with an exemplary embodiment of the invention, content services are provided. The content services provide the ability for an end user of the services to maintain the delivery of preferred radio station content through an audio system of a vehicle even when the vehicle has exited a radio broadcast range associated with the radio station content. The content services monitor the signal quality of a particular radio frequency-based broadcast signal. The content services also identify land or IP-based sources of the content, if available. If the signal quality falls below a pre-defined threshold level, and an IP-based source of the content is available, the content services seamlessly transition the presentation of the radio-based broadcast content to the IP-based content through the vehicle's audio system. The transition may occur transparently to the occupants of the vehicle. These and other features of the content services will now be described.

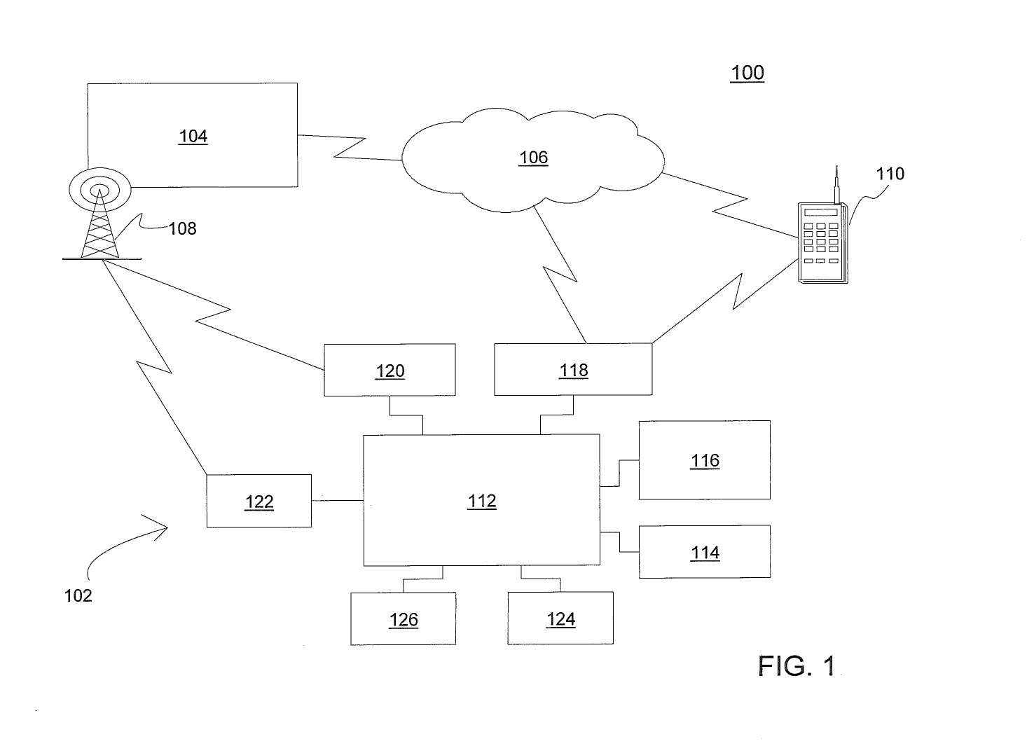

Turning now to FIG. 1, a system upon which content services may be implemented will now be described in accordance with an embodiment. The system 100 of FIG. 1 illustrates a portion of a vehicle 102 in communication with networks 106. The vehicle 102 may be any type of automobile. Also included in the system 100 are a radio broadcast provider system 104, a radio broadcast tower 108, and a mobile communication device 110.

The radio broadcast provider system 104 may be implemented by a radio station enterprise that provides content transmitted over-the-air as radio frequency-based signals via the radio broadcast tower 108. The radio frequency-based signals may be received by vehicles or other systems that employ associated receivers, and which are in geographic range of the radio broadcast tower 108. Thus, in this embodiment, if the radio broadcast provider system 104 represents a local radio station with regard to an operator of the vehicle 102, the vehicle 102 would not be capable of receiving the broadcast radio signals from the radio broadcast provider system's tower 108 when the vehicle 102 travels outside of a broadcast range of the system 104.

In an embodiment, the radio broadcast provider system 104 may also distribute the content using digital transmission technologies, e.g., streaming sound via digital packets distributed over one or more networks 106. In this embodiment, the radio broadcast provider system 104 employs an Internet Protocol-based address for enabling access to the digital transmissions.

In an embodiment, the mobile communication device 110 may be a smart phone. The mobile communication device 110 may receive cellular communications services from a service provider over a cellular network, such as one of the networks 106. In addition, the mobile communication device 110 may receive Internet-based content in addition to cellular-based communications over the networks 106. The mobile communication device 110 may also include a wireless interface that supports short-range wireless communications protocols, such as WiFi or Bluetooth®. The mobile communication device 110 may implement various applications including a global positioning system (GPS) component. In one embodiment, the mobile communication device 110 is operated by an occupant or driver of the vehicle 102.

In an embodiment, the networks 106 may be a combination of networks, such as, but not limited to, cellular networks, satellite networks, and the Internet.

The vehicle 102 of FIG. 1 includes a controller 112 that is communicatively coupled to a radio 114, input/output (I/O) components 116, a wireless interface 118, a backup tuner 120, an AM/FM tuner 122, and a storage device 126, either wirelessly or through wired connections (e.g., a communication bus). The controller 112 may include one or more computer processing circuits and may be implemented using various computer hardware and software technology known in the art, such as one or more processing units, volatile and non-volatile memory, power supplies, support circuitry, and operating systems. In an embodiment, logic 124 is configured for execution by the controller 112 for implementing the exemplary content services described herein. The logic 124 may be implemented in hardware, software, or a combination thereof. The controller 112 implements a digital-to-analog converter, which is used by the exemplary content services, as will be described further herein.

The radio 114 provides content to occupants of the vehicle 102 through the I/O components 116 of the vehicle 102, such as through program control buttons and audio speakers. The content includes music or other programming provided by the radio broadcast provider system 104 that are transmitted by the radio broadcast tower 108, using over-the-air using radio frequency-based signals, to any vehicles in range of the tower 108, such as the vehicle 102.

The vehicle 102 utilizes the AM/FM tuner 122 to enable searches for available over-the-air content based on radio frequencies associated with corresponding radio stations.

The I/O components 116 may include input buttons associated with the radio 114 (e.g., channel or program controls), as well as audio speakers for outputting the content to the vehicle occupants.

In one embodiment, the wireless interface 118 may include telematics components, such as a global positioning system component, mobile communications component, and related software. The mobile communications component may be configured to facilitate communications by vehicle occupants over the networks 106 using, e.g., code division multiple access (CDMA) wireless communications standards or global system for mobile communications (GSM) wireless communications standards. In one embodiment, the wireless interface 118 may be implemented by telematics components provided by a service provider, such as OnStar®. In another embodiment, the wireless interface 118 may include short-range wireless communications components, such as WiFi or Bluetooth®-enabled network interfaces. The wireless interface 118 features and functionality are described further herein.

In an embodiment, the backup tuner 120 is configured to monitor the quality of the broadcast radio frequency signal received by the vehicle 102 and which is tuned by the AM/FM tuner 122. The signal quality is provided to the logic 124 for analysis in determining whether to continue receiving broadcast of a radio signal or whether to transition over to a digital transmission, as will be described further herein.

In an embodiment, the content services may be configured to enable end users to define preferences, such as selecting one or more radio stations for which the content services will be employed. The preferences may be implemented using various techniques, such as by assignment of a selected radio station to a radio input control (i.e., radio station preset), which is saved in memory and used by the content services to identify preferred radio stations. In another embodiment, the preferences may be implemented using a web-based interface provided by a service provider associated with the content services. In yet a further embodiment, the preferences may be implemented through a fee-based agreement between a vehicle manufacturer and content providers, such as the radio broadcast provider system 104 or other entity, by establishing radio presets before the sale of the vehicle.

The storage device 126 of the vehicle 102 may store these preset assignments, as well as radio station identifiers, radio station coverage areas, and other information. The storage device 126 is logically addressable as a data source by the controller 112 and logic 124. Other information that may be stored by the storage device 126 may include a current location of the vehicle 102, a predicted travel path of the vehicle, current signal strength of a radio frequency-based broadcast signal, and an Internet connection status. These elements will be described further herein.

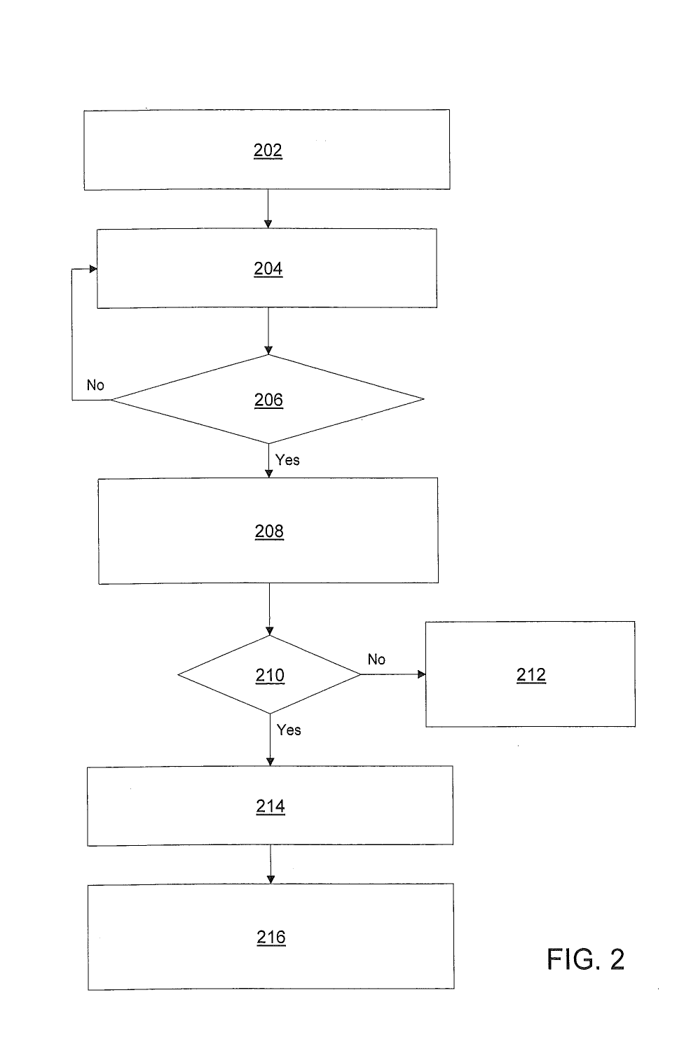

As indicated above, the content services enhance a vehicle occupant's entertainment experience by monitoring signals of radio frequency-based content active on the radio 114 and transition to digital content when the signal strength falls below a defined threshold level. Turning now to FIG. 2, a process for implementing the content services will now be described. The process described in FIG. 2 assumes that an end user has configured the content services for at least one selected radio station.

At step 202, the logic 124 determines the radio station identifier for the current content on the radio 114. The current content refers to music or programming presented on the radio 114, which has been received from the radio broadcast tower 108 via the AM/FM tuner 122. At step 204, the logic 124 monitors the quality of the signal strength for the radio frequency-based signal based on information provided to the logic 124 from the backup tuner 120. The content services may be configured to establish a threshold level of signal quality, such that any signal measurement falling below that threshold level is deemed unacceptable. The signal quality measure is referred to herein as a signal quality indicator value. In an embodiment, the coverage area information associated with the radio station identifier may be accessed from the storage device 126 to determine whether the vehicle 102 is approaching the outer limits of the coverage area. For example, the coverage area may be defined using GPS coordinates or other location information (e.g., from the wireless interface 118), and a current location of the vehicle 102 (e.g., via GPS coordinates of the vehicle from the wireless interface 118) may be used to determine where the vehicle 102 is relative to the coverage area limits.

At step 206, the logic 124 determines whether the signal quality indicator value has fallen below the threshold. If not, the logic 124 continues to monitor the signal quality from continued information received from the backup tuner 120. If, however, the signal quality indicator value has fallen below the threshold, the logic 124 accesses the networks 106 via the wireless interface 118 (and optionally, the mobile communication device 110) to search for the identifier at step 208. Alternatively, a listing of IP-based programming content sources can be stored in the storage device 126 and accessed via the identifiers along with network addresses of the content sources.

If the identifier is not found at step 210, this means that no alternate means of transmission (e.g., digital transmission) of the content is available from the radio broadcast provider system 104. In this instance, the logic 124 allows the radio 114 to continue presenting the radio frequency-based transmission of the content at step 212.

Otherwise, if the identifier is found at step 210, the logic 124 accesses the alternative source of the content, e.g., using the network address of the content source, via the wireless interface 118 (and optionally, the mobile communication device 110) at step 214. The alternate source of content may be a digital transmission of the content using packet-based communication technology. At step 216, the logic 124 converts the digital content to analog content, via the digital-to-analog converter of the controller 112, and transitions the transmission of the radio frequency-based content to the digital content. The transition may be transparent to the vehicle occupants. For example, the logic 124 may be configured to maintain the display of the call station identifier even when the alternative source of content is being presented.

In an embodiment, once the transitioning has completed, the logic 124 and controller 112 draws signals from the IP-based content servers through the wireless interface 118 (e.g., through the telematics components or through a cellular telephone and short-range Bluetooth or Wi-Fi connections), as long as the radio 114 is tuned to the corresponding radio station.

In an embodiment, the radio station identifiers may be stored in a look up table along with the radio station's Internet-based counterparts. The look up table may be maintained by radio content providers or third-party providers. Alternatively, a telematics service provider associated with the wireless interface 118 may collect and classify this information.

In a further embodiment, the logic 124 may be configured to periodically communicate with the IP-based content sources via the wireless interface 118 and provide a ‘state of health’ signal to the controller 112 that is indicative of the availability of these content sources over the networks 106. The backup tuner 120 likewise provides an indication of the strength of the radio broadcast signal to the controller 112. In this manner, the availability of the IP-based content sources is known before the quality of the radio broadcast signal reaches the threshold value, such that transitioning from the radio broadcast signal to the IP-based signal is seamless. In an embodiment, the transitioning between radio broadcast signals and IP-based signals can occur before the threshold value of the signal quality indicator value has been reached; however, the completion of the transitioning does not occur until the indicator value is determined.

Technical effects include providing the ability for an end user to maintain the delivery of preferred radio station content through an audio system of a vehicle even when the vehicle has exited a radio broadcast range associated with the radio station content. The content services monitor the signal quality of a particular radio frequency-based broadcast signal. The content services also identify land or IP-based sources of the content, if available. If the signal quality falls below a pre-defined threshold level, and an IP-based source of the content is available, the content services seamlessly transition the presentation of the radio-based broadcast content to the IP-based content through the vehicle's audio system. In this manner, the vehicle can maintain the programming of a local radio broadcast station throughout the duration of a driving event regardless of the coverage area associated with the local radio broadcast station.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the application.

What is claimed is:

1. A system for providing content services for a vehicle, comprising:
a wireless interface;
a computer processing device communicatively coupled to the wireless interface; and
logic executable by the computer processing device, the logic configured to implement a method, the method comprising:
receiving a signal quality indicator value indicative of a signal quality of a radio station that is transmitting radio frequency-based content over-the-air, the content received by the vehicle;
searching, via the wireless interface, a network for an identifier of the radio station; and
upon determining the signal quality indicator value has fallen below a threshold, and responsive to finding the identifier of the radio station from the searching, transitioning from transmission of the content broadcast via radio frequency-based signals, through a radio of the vehicle, to transmission of content associated with the network, the transitioning performed transparently to an occupant of the vehicle.

2. The system of claim 1, wherein the wireless interface includes a global positioning system component and a mobile communications component of a telematics system integrated with the vehicle;
wherein searching the network includes searching for an Internet Protocol address of the radio station, the method further comprising:
using global positioning system coordinates derived from the global positioning system component to identify the vehicle with the telematics system and the radio station discovered from searching the network; and
transmitting the content from the network through the radio of the vehicle.

3. The system of claim 1, wherein the wireless interface includes a global positioning system component and a mobile communications component of a mobile communication device;
wherein searching the network includes searching for an Internet Protocol address of the radio station, the method further comprising:
using global positioning system coordinates derived from the global positioning system component to identify the vehicle with the mobile communication device and the radio station discovered from searching the network; and
transmitting the content through a radio of the vehicle via a short-range communication network configured between the mobile communication device and a controller of the vehicle.

4. The system of claim 1, wherein the radio includes pre-configured presets, and wherein the receiving, searching, and transitioning is performed only for radio stations assigned to the pre-configured presets.

5. The system of claim 1, further comprising input components of the radio, the method further comprising:
activating a service for performing the receiving, searching, and transitioning via the input components of the radio;
wherein the transitioning is performed transparently to an occupant of the vehicle.

6. The system of claim 1, wherein the logic is further configured to implement:
receiving a request to activate a service for performing the receiving, searching, and transitioning via a web-based interface.

7. The system of claim 1, wherein the logic is further configured to implement:
displaying a call sign of the radio station that previously broadcast the content over-the-air, while transmitting the content associated with the network over the radio.

8. A method for providing content services for a vehicle, comprising:
receiving, at a computer processing device, a signal quality indicator value indicative of a signal quality of a radio station that is transmitting radio frequency-based content over-the-air, the content received by the vehicle;
searching, via a wireless interface that is communicatively coupled to the computer processing device, a network for an identifier of the radio station; and
upon determining the signal quality indicator value has fallen below a threshold, and responsive to finding the identifier of the radio station from the searching, transitioning from transmission of the content broadcast via radio frequency-based signals, through a radio of the vehicle, to transmission of content associated with the network, the transitioning performed transparently to an occupant of the vehicle.

9. The method of claim 8, wherein searching the network includes searching for an Internet Protocol address of the radio station, the method further comprising:
using global positioning system coordinates derived from a global positioning system component of the wireless interface to identify the vehicle with a telematics system and the radio station discovered from searching the network; and
transmitting the content through the radio of the vehicle.

10. The method of claim 8, wherein searching the network includes searching for an Internet Protocol address of the radio station, the method further comprising:
using global positioning system coordinates derived from a global positioning system component of a mobile communication device to identify the vehicle with the mobile communication device and the radio station discovered from searching the network; and
transmitting the content through the radio of the vehicle via a short-range communication network configured between the mobile communication device and a controller of the vehicle.

11. The method of claim 8, wherein the receiving, searching, and transitioning is performed only for radio stations assigned to pre-configured presets of the radio.

12. The method of claim 8, further comprising:
activating a service for performing the receiving, searching, and transitioning via input components of the radio;
wherein the transitioning is performed transparently to an occupant of the vehicle.

13. The method of claim 8, further comprising:
receiving a request to activate a service for performing the receiving, searching, and transitioning via a web-based interface.

14. The method of claim 8, further comprising:
displaying a call sign of the radio station that previously broadcast the content over-the-air, while transmitting the content associated with the network over the radio.

15. A computer program product for providing content services for a vehicle, the computer program product comprising a computer storage medium embodied with program instructions, which when executed by a computer processor cause the computer processor to implement a method, the method comprising:
receiving a signal quality indicator value indicative of a signal quality of a radio station that is transmitting radio frequency-based content over-the-air, the content received by the vehicle;
searching, via a wireless interface that is communicatively coupled to the computer processing device, a network for an identifier of the radio station; and
upon determining the signal quality indicator value has fallen below a threshold, and responsive to finding the identifier of the radio station from the searching, transitioning from transmission of the content broadcast via radio frequency-based signals, through a radio of the vehicle, to transmission of content associated with the network, the transitioning performed transparently to an occupant of the vehicle.

16. The computer program product of claim 15, wherein searching the network includes searching for an Internet Protocol address of the radio station, the method further comprising:
using global positioning system coordinates derived from a global positioning system component of the wireless interface to identify the vehicle with a telematics system and the radio station discovered from searching the network; and
transmitting the content through the radio of the vehicle.

17. The computer program product of claim 15, wherein searching the network includes searching for an Internet Protocol address of the radio station, the method further comprising:
using global positioning system coordinates derived from a global positioning system component of a mobile communication device to identify the vehicle with the mobile communication device and the radio station discovered from searching the network; and
transmitting the content through the radio of the vehicle via a short-range communication network configured between the mobile communication device and a controller of the vehicle.

18. The computer program product of claim 15, wherein the receiving, searching, and transitioning is performed only for radio stations assigned to pre-configured presets of the radio.

19. The computer program product of claim 15, wherein the method further comprises:
activating a service for performing the receiving, searching, and transitioning via input components of the radio.

20. The computer program product of claim 15, wherein the method further comprises:
receiving a request to activate a service for performing the receiving, searching, and transitioning via a web-based interface;
wherein the transitioning is performed transparently to an occupant of the vehicle.
